(19) United States
(12) Patent Application Publication
(10) Pub. No.: US 2023/0075306 A1
(43) Pub. Date: Mar. 9, 2023

(54) DEVICE FOR DISPENSING MEDIA

(71) Applicant: Kenzinc LLC, 17900816, CT (US)

(72) Inventor: Drew Pickering, Oxford, CT (US)

(21) Appl. No.: 17/900,816

(22) Filed: Aug. 31, 2022

Related U.S. Application Data
(60) Provisional application No. 63/239,577, filed on Sep. 1, 2021.

(51) Int. Cl. G01F 19/00

(52) U.S. Cl. CPC G01F 19/002

(57) ABSTRACT

The present disclosure relates to dispensing devices, and more particularly, to a dispenser that includes a scoop portion that is pinchable to form a spout to facilitate the transferring of metered amounts of a substance (i.e., a fluid or a particulate) to a container having a small mouth. This allows a user to easily supply metered amounts of a substance to a container having a small mouth while minimizing spillage, thereby improving the accuracy of the measurement and avoiding waste of the substance.

### BACKGROUND

The present disclosure relates to dispensing devices, and more particularly, to a dispenser that includes a scoop portion that is pinchable to form a spout to facilitate the transferring of metered amounts of a substance (i.e., a fluid or a particulate) to a container having a small mouth.

### 1. Background of the Related Art

Newborn babies are often fed, at least partly, by using powdered milk products. In making the milk, the amount of powder used in the formula must be carefully measured and transferred to a container to be mixed with water. Since powdered milk products often do not contain preservatives and spoil within 48 hours, they are usually mixed in single serving portions. As a result, parents typically mix the formula directly in the baby bottle. However, baby bottles typically have a very small mouth, making it difficult to transfer the carefully-measured powder to the bottle without spilling a portion of the powder.

Many nutritional and fitness supplements are also sold in powdered form. Like powdered milk, these supplements are mixed with water or other liquids to obtain a desired end-product. Typically, a single serving mixture is created to eliminate the need to store or carry large quantities of liquid. For example, a hiker can easily carry a one week's supply of a supplement or energy drink in powdered form, but could not reasonably carry the equivalent amount of the supplement in liquid form. Consequently, the hiker will normally carry a small bottle for use in mixing individual servings of the supplement. Like traditional baby bottles, a hiker's bottle has a small mouth making it difficult to measure and transfer the powdered supplement without spillage.

U.S. Pat. No. 6,470,745 to Reay et al. discloses a prior dispenser for powdered baby milk. The Reay et al. dispenser includes a handle, a scoop having an open mouth for receiving the powdered milk and a leveling mechanism for ensuring an accurate quantity of powder is obtained. Prior dispensers, like that disclosed in Reay et al., are well-suited for quickly scooping a desired amount of powder, but they are poorly-suited for delivering the powder to the mixing container or bottle without spillage. The Reay et al. dispenser, and others like it, have a scoop with a wide or large diameter mouth. The mouth typically has a diameter equivalent to that of the cylindrical scoop body so that air pockets are not formed in the scooped powder, thereby enhancing accurate measurement. As a consequence of the wide mouths on prior scoops, however, spillage occurs when attempting to transfer the powder to a baby bottle or small-mouthed container, thereby defeating the user's careful measurement of the powder that took place prior to the transfer.

As noted above, a common problem associated with prior dispensers for use with powdered products is the ability to transfer the measured product to the mixing receptacle without spilling the product. Still further, prior devices are difficult to clean and not easily manufactured. For example, U.S. Pat. No. 5,884,523 to Cheng et al. discloses a scoop that includes a counter to assist in remembering the number of scoops that have been put into the bottle. Although the counting device has utility, the utility is thwarted due to the spillage that occurs when transferring the product to the container or bottle. Still further, the disclosed counting mechanism adds significantly to the cost of the dispenser and complicates cleaning the device.

Therefore, there is a need for a dispenser capable of easily and quickly supplying metered amounts of a substance to a container having a small mouth without spillage. Still further, there is a need for a dispenser that in addition to eliminating spillage, is inexpensive to manufacture and easy to clean for reuse.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure relates to a dispensing device for dispensing media.

In one embodiment, a dispensing device includes a handle portion, and a scoop portion. The scoop portion may include a proximal end formed on or coupled to the handle portion, and a distal end having deformable surfaces formed thereon. The scoop portion may further include a pair of pinchable surfaces, wherein engaging the pair of pinchable surfaces causes the deformable surfaces to form a spout at the distal end of the scoop portion.

The device of the present invention allows a user to easily supply metered amounts of a substance to a container having a small mouth while minimizing spillage. This improves the accuracy of the measurement and avoids wasting portions of the substance. In addition, the device is relatively inexpensive to manufacture and easy to clean for reuse.

In embodiments, the handle portion further comprises a window.

In embodiments, the dispensing device is made from a formable material suitable for single-piece molded construction.

In embodiments, the dispensing device is made from polypropylene.

In embodiments, the deformable surface is biased towards a central portion of the scoop portion.

In other embodiments, the scoop portion further includes a formed surface on a bottom surface of the scoop portion. In embodiments, the formed surface extends across a diameter of the bottom surface of the scoop portion. In embodiments, the formed surface extends along a longitudinal axis defined by the handle portion.

In embodiments, the pair of pinchable surfaces are formed on substantially opposing surfaces of the scoop portion. In embodiments, the pair of pinchable surfaces are formed on a generally central portion of the scoop portion. In embodiments, the pair of pinchable surfaces are formed on a proximal end of the scoop portion.

In embodiments, the pair of pinchable surfaces are a pair of pinchable handle members. In other embodiments, the pair of pinchable surfaces are a pair of pinchable winged projections. In embodiments, the deformable surfaces have an initial shape and the deformable surfaces return to their initial shape after forming the spout.

In another aspect, the present disclosure relates to a dispensing device including a handle portion, and a scoop portion having a proximal end formed on or coupled to the handle portion, and a distal end having deformable surfaces formed thereon. The deformable surfaces further include a cutting edge. The cutting edge may be formed on at least a portion of an inner circumferential surface of the scoop portion. The scoop portion may further include a pair of pinchable surfaces, wherein engaging the pinchable surfaces causes the deformable surfaces to form a spout at the distal end of the scoop portion.

In embodiments, the cutting edge is formed along the entirety of the inner circumference of the scoop portion.

In embodiments, the handle portion further comprises a window. The dispensing device may be made from a formable material suitable for single-piece molded construction.

In embodiments, the scoop portion defines an upper opening for receiving a powdered substance, the cutting edge facing the upper opening.

In embodiments, the scoop portion further comprises a formed surface on a bottom surface of the scoop portion. The formed surface may extend across a diameter of the bottom surface of the scoop portion. The formed surface may extend along a longitudinal axis defined by the handle portion.

In embodiments, the scoop portion further includes a pair of pinchable surfaces, wherein engaging the pair of pinchable surfaces causes the deformable surfaces to form a spout at the distal end of the scoop portion. The pair of pinchable surfaces may be formed on substantially opposing surfaces of the scoop portion. The pair of pinchable surfaces may be formed on a generally central portion of the scoop portion. The pair of pinchable surfaces may be formed on a proximal end of the scoop portion. In embodiments, the deformable surfaces have an initial shape and the deformable surfaces return to their initial shape after forming the spout.

In embodiments, the pair of pinchable surfaces comprise a pair of pinchable handle members. In embodiments, the pair of pinchable surfaces comprise a pair of pinchable winged projections.

In another aspect, a method of transferring a powdered substance to a vessel, comprising scooping the powdered substance with a dispensing device, the dispensing device having deformable surfaces, engaging the dispensing device to form a spout at a distal end of the dispensing device, and delivering the powdered substance to the vessel through the spout.

In embodiments, the dispensing device has pinchable surfaces, the deformable surfaces forming the spout when the pinchable surfaces are pinched. In embodiments, the method includes returning the spout to an initial shape. In embodiments, the pinchable surfaces are engaged to return the spout to the initial shape. Scooping may include cutting through the powdered substance with a cut through surface of the dispensing device.

### BRIEF DESCRIPTION OF THE DRAWINGS

The above and other aspects, features, and advantages of the present devices for dispensing media will become more apparent in light of the following detailed description when taken in conjunction with the accompanying drawings in which:

FIG. 1 is a perspective overhead view of a pinchable dispensing device in accordance with the present disclosure in an unpinched configuration;

FIG. 2 is a perspective overhead view of a pinchable dispensing device in accordance with the present disclosure that has been pinched to form a spout;

FIG. 3 is a perspective overhead view of a pinchable dispensing device in accordance with the present disclosure having a formed surface on the bottom surface of the pinchable dispensing device;

FIG. 4 is a perspective overhead view of a pinchable dispensing device in accordance with the present disclosure in which the pinchable surfaces have been adjusted radially;

FIG. 5 is a perspective overhead view of an alternate embodiment of a pinchable dispensing device in accordance with the present disclosure having a cutting edge formed thereon;

FIG. 5A is a perspective side view of the alternate embodiment of a pinchable dispensing device in accordance with FIG. 5;

FIG. 6 is a perspective overhead view of an alternate embodiment of a pinchable dispensing device in accordance with the present disclosure having a pair of pinchable handle members;

FIG. 7 is a perspective overhead view of an alternate embodiment of a pinchable dispensing device in accordance with the present disclosure having a pair of pinchable handle members;

FIG. 8 is a perspective overhead view of an alternate embodiment of a pinchable dispensing device in accordance with the present disclosure having a pair of pinchable winged projections; and

FIG. 9 is a perspective overhead view of an alternate embodiment of a pinchable dispensing device in accordance with the present disclosure having a pair of pinchable winged projections.

### DETAILED DESCRIPTION

Particular embodiments of the present dispensing devices are described hereinbelow with reference to the accompanying drawings; however, it is to be understood that the disclosed embodiments are merely exemplary of the disclosure and may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Well-known functions or constructions are not described in detail to avoid obscuring the present disclosure in any unnecessary detail.

Referring now to the drawings, FIG. 1 depicts a pinchable dispensing device 100 for use in scooping media from a container and transferring that substance without spillage to a receptacle having a small mouth, such as a water bottle, baby bottle or any other similar vessels. The media is, for example, any powdered substance such as a powder milk product used to feed an infant, or a nutritional substance used by an athlete, coffee, tea, or any other media that may be easily scooped by the presently described pinchable dispensing device. The substance need not be a fine powder, but may be, for example, a granular particulate or liquid.

FIG. 1 is an overhead perspective view of an illustrative pinchable dispensing device 100 in accordance with embodiments of the present disclosure. Pinchable dispensing device 100 includes an elongated handle 102 having a proximal end 103 and a distal end 104, and a scoop 110 having a proximal end 111 formed on or coupled to elongated handle 102, and a distal end 112. In embodiments, proximal end 111 of scoop 110 and distal end 104 of elongated handle 102 may be formed from a single piece molded construction such that elongated handle 102 is formed on the proximal end 111 of scoop 110. Scoop 110 further includes pinchable surfaces 115 and a distal deformable surface 120. Scoop 110 further includes an upper opening for receiving a powdered substance or scoopable media within scoop 110.

In embodiments, pinchable dispensing device 100 and the components thereof may be made from any suitable moldable or formable material. Suitable materials may include but are not limited to nylon (polyamide), acrylic, polyoxymethylene (POM), polystyrene (PS), acrylonitrile butadiene styrene (ABS), polypropylene (PP), polyethylene, thermoplastic polyurethane (TPU), thermoplastic rubber (TPR), high density polyethylene (HDPE), low density polyethylene (LDPE), polyvinyl chloride (PVC), polyethylene terephthalate (PET), and thermoplastic elastomers (TPE). In embodiments, pinchable dispensing device 100 is made using a single-piece molded construction.

In FIG. 1, illustrative pinchable dispensing device 100 is in the default unpinched configuration. In the unpinched configuration, deformable surface 120 may extend towards a central portion of scoop 110. In embodiments, pinchable dispensing device 100 may include a window 105 formed on elongated handle 102 for excess unwanted media to pass through during scooping. Additionally, elongated handle 102 may be curved or contoured to prevent accumulation of unwanted media on any surface of elongated handle 102.

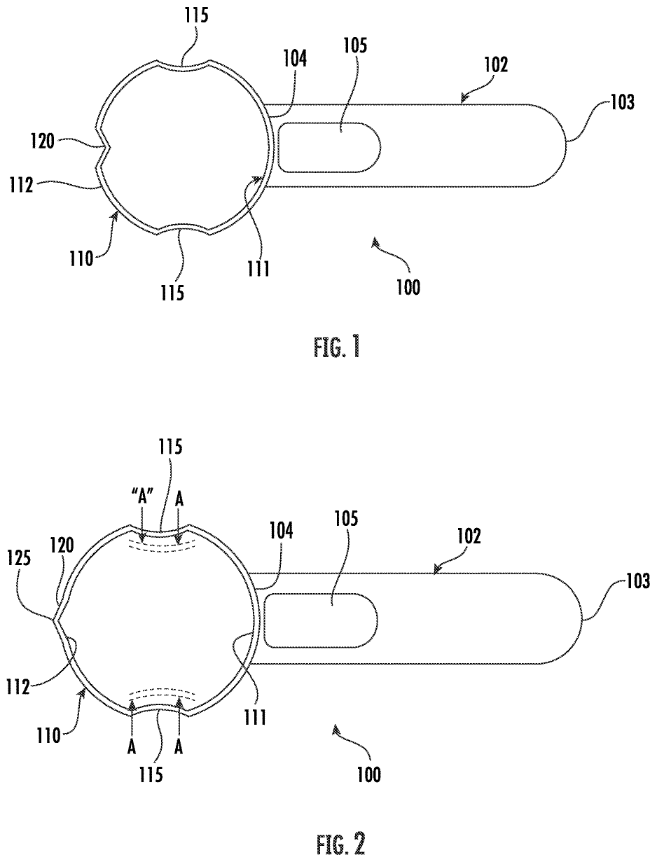

Once a user has scooped media into scoop 110, pinchable dispensing device 100 may be pinched to form a spout to then transfer the media into a desired vessel. FIG. 2 depicts pinchable dispensing device 100 in a pinched configuration.

In FIG. 2, pinchable surfaces 115 are shown being pinched inwardly in the direction of Arrows “A” toward a central portion of scoop 110. As a user compresses pinchable surfaces 115 towards a central portion of scoop 110, deformable surface 120 flexes to extend away from the central portion of scoop 110 to form a spout 125. As shown in FIG. 2, once deformable surface 120 has formed spout 125, a user may more easily transfer media from scoop 110 into a desired vessel having a smaller opening size. The scoop 110, in any of the embodiments disclosed herein, can have aany geometric shape, such as generally round, square, oblong, rectangular, oval, pyramidal, etc. The pinchable surfaces and/or spout 125, in any of the embodiments disclosed herein, can be permanently deformable, or may return to their original shape.

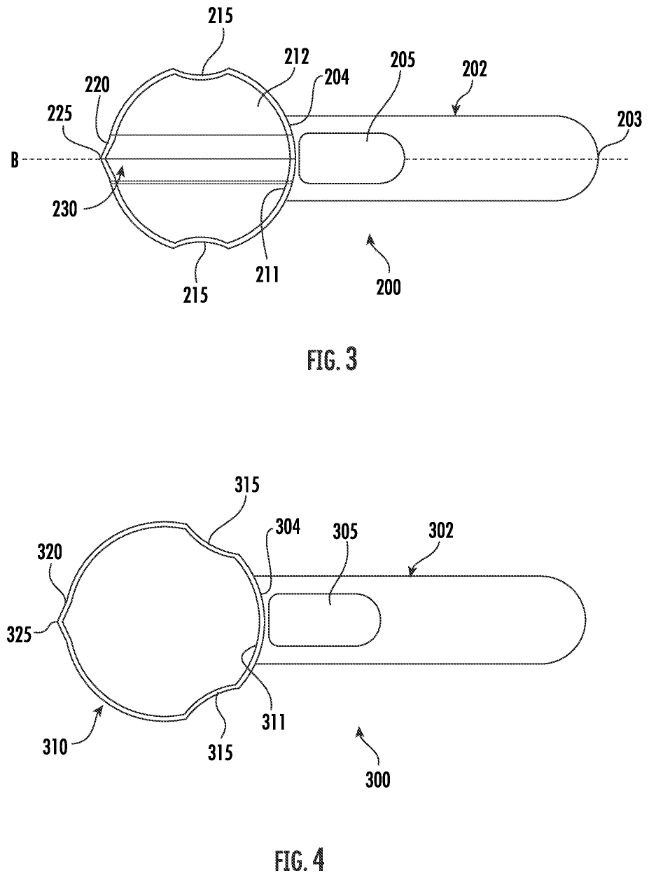

FIG. 3 depicts an alternate embodiment of a pinchable dispensing device 200. As in the previous embodiments, device 200 includes an elongated handle 202 with a proximal end 203 and a distal end 204 formed on or coupled to a scoop 210. Handle 202 may contoured and may further include a window 205 for excess unwanted media to pass through during scooping. Scoop includes pinchable surfaces 215 and a deformable surface 220 that forms a spout 225.

In this embodiment, pinchable dispensing device 200 includes a formed area 230 on a bottom surface 212 of a scoop 210. In embodiments, formed area 230 may extend longitudinally along an axis “B” defined by elongated handle 202; however, it is envisioned that in alternative embodiments the orientation and configuration of formed area 230 may be varied to complement the position of the deformable surface and the pinchable surfaces of a given scoop. In use, formed area 230 helps facilitate the folding of scoop 210 to create spout 225 upon depressing pinchable surfaces 215, causing formed area 230 to flex in response.

In alternative embodiments, the position of the pinchable surfaces of a given scoop may be rotated radially. For example, FIG. 4 depicts an alternative embodiment in accordance with the present disclosure in which a pinchable dispensing device 300 comprising a contoured elongated handle 302 having a window 305 and a distal end 304 formed on or coupled to a proximal end 311 of scoop 310. Scoop 310 includes pinchable surfaces 315 and a deformable surface 320 that forms a spout 325, as in previous embodiments. In this embodiment, pinchable surfaces 315 have been translated radially towards elongated handle 302 such that they are closer to handle 302 than in the previous embodiments. Of course, it will be recognized that other embodiments are possible. For example, pinchable surfaces 315 may be translated radially towards spout 325 such that they are closer to spout 325 than in the embodiments shown in FIGS. 1 and 2.

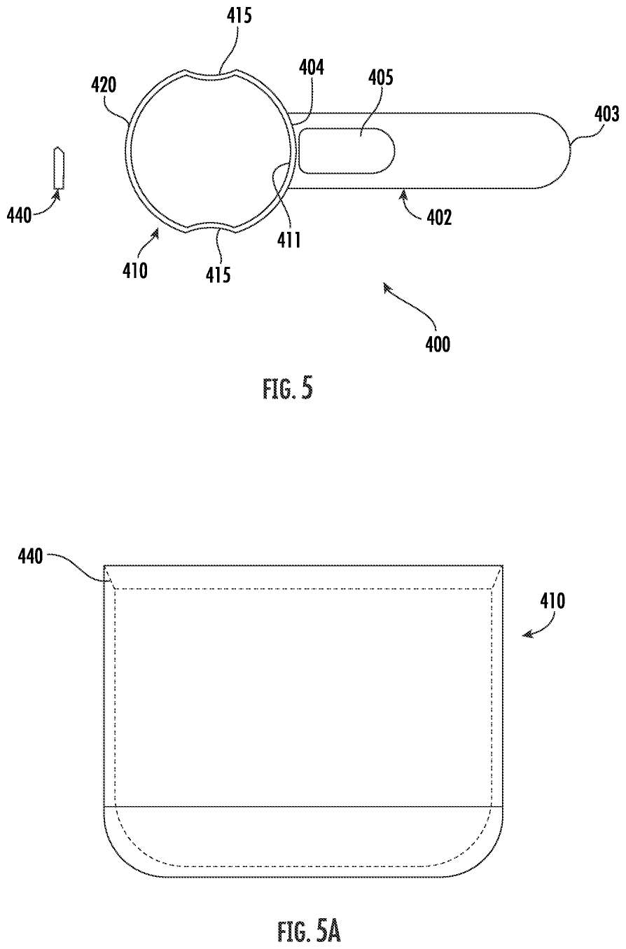

FIG. 5 depicts an alternative embodiment of a pinchable dispensing device 400 in accordance with the present disclosure. As in previous embodiments, device 400 includes a contoured elongated handle 402 having a window 405, a proximal end 403 and a distal end 404 formed on or coupled to a proximal end 411 of a scoop 410. Scoop 410 includes pinchable surfaces 415 and a deformable surface 420. In this embodiment, scoop 410 includes a cut through edge 440. As shown in FIG. 5A, cut through edge 440 may be formed along the inner circumference of scoop 410. Cut through edge 440 may be formed along a portion of the inner circumference of scoop 410, or in embodiments, the entirety of the inner circumference of scoop 410. The cut through edge 440 may be formed on the upper portion of the scoop, along a portion of it, or provided on a separate part attached to the scoop. The height of cut through edge 440 as compared to the height of the scoop, and the angle of cut through edge 440 may be adjusted as desired. Engaging pinchable surfaces 415 operates similarly to previously described embodiments to cause deformable surfaces 420 to form a spout. However, cut through edge 440 allows a user to cut through various types of media (such as powder) during scooping, rather than plowing through it. Furthermore, cut through edge 440, when compared to a typical straight edge, helps to prevent flexing of elongate handle 402 during scooping.

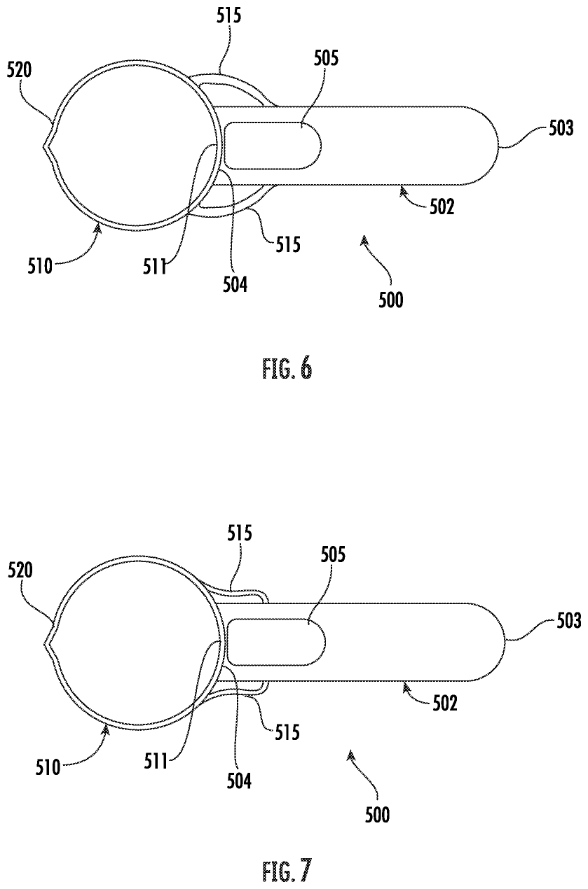

FIGS. 6 and 7 depict an alternative embodiment of a pinchable dispensing device 500 in accordance with the present disclosure. As in previous embodiments, device 500 includes a contoured elongated handle 502 having a window 505, a proximal end 503 and a distal end 504 formed on or coupled to a proximal end 511 of a scoop 510. In the embodiments depicted in FIGS. 6 and 7, a pair of pinchable handle members 515 extend between a portion of scoop 410 and elongated handle 502. Engaging pinchable handle members 415 operates similarly to previously described embodiments to cause deformable surfaces 520 to form a spout. Pinchable handle members 515 may be contoured to prevent accumulation of scoopable media on its surface. As shown in FIGS. 6 and 7, the curvature and shape of pinchable handle members 515 may be adjusted as desired.

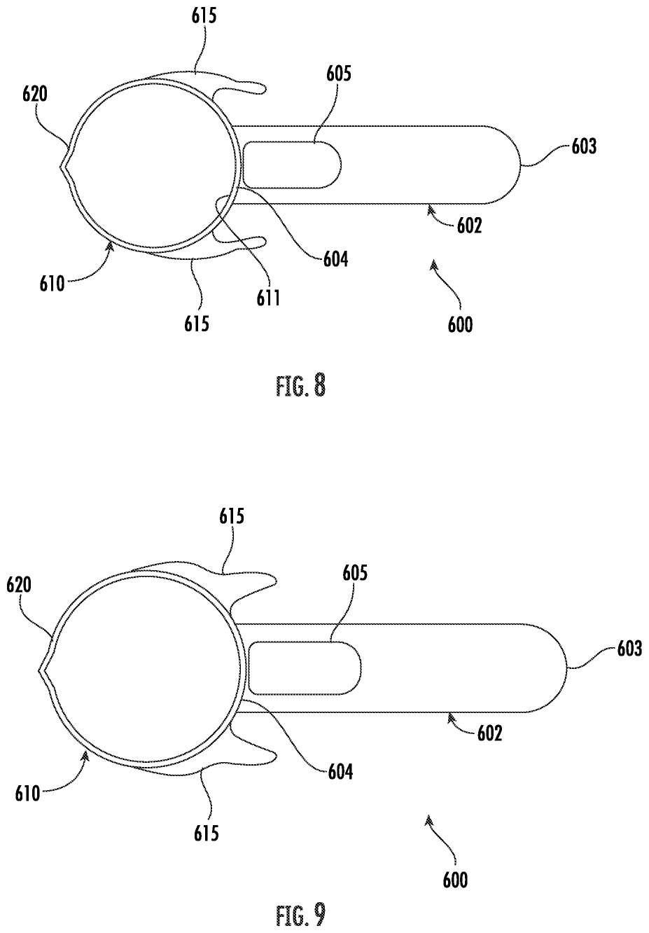

FIGS. 8 and 9 depict an alternative embodiment of a pinchable dispensing device 600 in accordance with the present disclosure. As in previous embodiments, device 600 includes a contoured elongated handle 602 having a window 605, a proximal end 603 and a distal end 604 formed on or coupled to a proximal end 611 of a scoop 610. In the embodiments depicted in FIGS. 8 and 9, a pair of pinchable winged projections 615 are formed on the outer edge of scoop 610. Engaging pinchable winged projections 615 operates similarly to previously described embodiments to cause deformable surfaces 620 to form a spout. As shown in FIGS. 8 and 9, the shape, length, and width of pinchable winged projections 615 may be adjusted as desired.

While several embodiments have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of presently disclosed embodiments. Thus, the scope of the embodiments should be determined by the appended claims and their legal equivalents, rather than by the examples given.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Various alternatives and modifications can be devised by those skilled in the art without departing from the disclosure. Accordingly, the present disclosure is intended to embrace all such alternatives, modifications and variances. As well, one skilled in the art will appreciate further features and advantages of the present disclosure based on the above-described embodiments. Accordingly, the present disclosure is not to be limited by what has been particularly shown and described, except as indicated by the appended claims.

1. A dispensing device comprising:
a handle portion; and
a scoop portion having a proximal end formed on or coupled to the handle portion, and a distal end having deformable surfaces formed thereon;
wherein the scoop portion further includes a pair of pinchable surfaces, wherein engaging the pair of pinchable surfaces causes the deformable surfaces to form a spout at the distal end of the scoop portion.

2. The dispensing device of claim 1, wherein the handle portion further comprises a window.

3. The dispensing device of claim 2, wherein the dispensing device is made from a formable material suitable for single-piece molded construction.

4. The dispensing device of claim 3, wherein the deformable surface is biased towards a central portion of the scoop portion.

5. The dispensing device of claim 4, wherein the scoop portion further comprises a formed surface on a bottom surface of the scoop portion.

6. The dispensing device of claim 5, wherein the formed surface extends across a diameter of the bottom surface of the scoop portion.

7. The dispensing device of claim 6, wherein the formed surface extends along a longitudinal axis defined by the handle portion.

8. The dispensing device of claim 4, wherein the pair of pinchable surfaces are formed on substantially opposing surfaces of the scoop portion.

9. The dispensing device of claim 8, wherein the pair of pinchable surfaces are formed on a generally central portion of the scoop portion.

10. The dispensing device of claim 9, wherein the pair of pinchable surfaces are formed on a proximal end of the scoop portion.

11. The dispensing device of claim 1, wherein the deformable surfaces have an initial shape and the the deformable surfaces return to their initial shape after forming the spout.

12. A dispensing device comprising:
a handle portion;
a scoop portion having a proximal end formed on or coupled to the handle portion, a distal end having deformable surfaces formed thereon, and an inner circumferential surface; and
a cutting edge formed on a least a portion of the inner circumferential surface.

13. The dispensing device of claim 12, wherein the handle portion further comprises a window.

14. The dispensing device of claim 12, wherein the dispensing device is made from a formable material suitable for single-piece molded construction.

15. The dispensing device of claim 12, wherein the scoop portion defines an upper opening for receiving a powdered substance, the cutting edge facing the upper opening.

16. The dispensing device of claim 12, wherein the cutting edge is formed along the entirety of the inner circumference of the scoop portion.

17. The dispensing device of claim 12, wherein the scoop portion further comprises a formed surface on a bottom surface of the scoop portion.

18. The dispensing device of claim 17, wherein the formed surface extends across a diameter of the bottom surface of the scoop portion.

19. The dispensing device of claim 18, wherein the formed surface extends along a longitudinal axis defined by the handle portion.

20. The dispensing device of claim 12, wherein the scoop portion further includes a pair of pinchable surfaces, wherein engaging the pair of pinchable surfaces causes the deformable surfaces to form a spout at the distal end of the scoop portion.

21. The dispensing device of claim 20, wherein the deformable surfaces have an initial shape and the deformable surfaces return to their initial shape after forming the spout.

22. The dispensing device of claim 20, wherein the pair of pinchable surfaces are formed on substantially opposing surfaces of the scoop portion.

23. The dispensing device of claim 20, wherein the pair of pinchable surfaces are formed on a generally central portion of the scoop portion.

24. The dispensing device of claim 20, wherein the pair of pinchable surfaces are formed on a proximal end of the scoop portion.

25. The dispensing device of claim 20, wherein the pair of pinchable surfaces comprise a pair of pinchable handle members.

26. The dispensing device of claim 20, wherein the pair of pinchable surfaces comprises a pair of pinchable winged projections.

27. A method of transferring a powdered substance to a vessel, comprising scooping the powdered substance with a dispensing device, the dispensing device having deformable surfaces, engaging the dispensing device to form a spout at a distal end of the dispensing device, and delivering the powdered substance to the vessel through the spout.

28. The method of claim 27, wherein the dispensing device has pinchable surfaces, the deformable surfaces forming the spout when the pinchable surfaces are pinched.

29. The method of claim 27, further comprising returning the spout to an initial shape.

30. The method of claim 28, further comprising engaging the pinchable surfaces to return the spout to the initial shape.

31. The method of claim 27, wherein scooping includes cutting through the powdered substance with a cut through surface of the dispensing device.
